(19) United States
(12) Patent Application Publication
(10) Pub. No.: US 2023/0342866 A1
(43) Pub. Date: Oct. 26, 2023

(54) INTEGRATION WITH SOCIAL MEDIA PROFILES

(71) Applicant: UPHABIT INC., Toronto (CA)

(72) Inventor: Neil WAINWRIGHT, Toronto (CA)

(21) Appl. No.: 18/025,472

(22) PCT Filed: Sep. 8, 2021
(86) PCT No.: PCT/CA2021/000083

§ 371 Date: Mar. 9, 2023

Related U.S. Application Data
(60) Provisional application No. 63/076,348, filed on Sep. 9, 2020.
(60) Provisional application No. 63/076,357, filed on Sep. 9, 2020.

(51) Int. Cl. G06Q 50/00; H04M 1/72448

(52) U.S. Cl. CPC G06Q 50/01; H04M 1/72448

(57) ABSTRACT

A method for linking social media profiles to a contact tab in a software application, such as a software application for managing a network of contacts, enables linked social media profiles to be accessed by a user with one press of a corresponding social media button in the contact tab. A further method for supplementing information about an existing contact in a user's contact list and proposing new contacts to add to the user's contact list by analyzing the user's emails is disclosed. The methods may be implemented by executing a software application on a computer or mobile device.

### FIELD OF THE DISCLOSURE

This disclosure relates to contact lists and maintaining contacts in a network application.

### BACKGROUND OF THE DISCLOSURE

Social media profiles contain large amounts of information about people in a network. However, it can be difficult to connect to relevant social media profiles in an application.

Therefore, improved methods and systems are needed.

### SUMMARY OF THE DISCLOSURE

The disclosure describes a software application and related method for linking social media profiles to a contact tab in a software application, such as a software application for managing a network of contacts, whereby linked social media profiles may be accessed by a user with one press of a corresponding social media button in the contact tab. The method, which may be implemented by executing the software application on a system such as a computer, may generally comprise the steps of displaying, using a processor, a social media button in a contact tab for a contact in an application, wherein the social media button represents a social media platform and is not enabled; receiving, using the processor, a button press input from a user pressing the social media button; performing, using the processor, a search for a social media profile for the contact in response to the button press input; displaying, using the processor, a list of social media profile search results; receiving, using the processor, an input from the user selecting a desired social media profile from the list of social media profile search results; linking, using the processor, the selected social media profile to the social media button; and enabling, using the processor, the social media button such that the selected social media profile is accessible by pressing the social media button. Once the social media button is enabled, the user may access the social media profile for the contact with a single press of the social media button.

In a further aspect of the present disclosure, the software application may be configured to execute a method for supplementing information about an existing contact in a user's contact list and proposing new contacts to add to the user's contact list by scanning the user's email messages. The method may generally comprise analyzing, using a processor, an email for information about a contact; determining, using the processor, whether the contact is an existing contact in an application contact list or a potential new contact not currently in the application contact list based on the analyzed information; automatically discarding, using the processor, the email after the analyzing is complete; updating information about the contact in the application contact list if the contact is an existing contact in the application contact list; and adding the contact to the application contact list if the contact is a potential new contact not currently in the application contact list.

### DESCRIPTION OF THE DRAWINGS

For a fuller understanding of the nature and objects of the disclosure, reference should be made to the following detailed description taken in conjunction with the accompanying drawings, in which:

FIG. 1 is a flow diagram illustrating a process for linking a social media profile of a contact to an application in accordance with an embodiment of the present disclosure;

FIG. 2 is a screenshot of a contact tab in the application;

FIG. 3 is a screenshot of a search window in the application for performing a social media profile search;

FIG. 4 is another screenshot of the contact tab of FIG. 2 after a LinkedIn social media button is enabled;

FIG. 5 is a screenshot of a LinkedIn profile accessed via the LinkedIn social media button in FIG. 4;

FIG. 6 is a flow diagram illustrating a process for adding new contact information and updating existing contact information in an application in accordance with an embodiment of the present disclosure;

FIG. 7 is a screenshot of a settings page by which a user may establish permissions for the process shown in FIG. 6;

FIG. 8 is a block diagram of a mobile device configured to execute an application according to an embodiment of the present disclosure; and

FIG. 9 is a block diagram of a computer system configured to execute an application according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Embodiments disclosed herein enable one-tap or one-click access to a contact's social media profiles. Social media services such as Facebook, Instagram, LinkedIn, Skype, Telegram, Twitter, WhatsApp, YouTube, or others can be accessed via the one-tap or one-click access of the present disclosure.

In a first aspect of the disclosure, a process is provided for linking one or more social media profiles corresponding to a contact in a contact list of an application (e.g. a mobile application or a web application) such that each linked social media profile is easily accessible to the application user. For sake of describing the process by example, and without limiting the process, the present disclosure references a mobile application named “UpHabit” that has a contact list stored by a user of the UpHabit application. The description refers to “tapping” a button or icon in the mobile application, however those skilled in the art will understand that this is one example for selecting an application element and is analogous to “clicking” in an element in a web application. The terms “press” and “pressing” a button, an icon, or another element in a displayed screen of an application are used in the claims to generically refer to and encompass “tap” and “tapping” and also “click” and “clicking.”

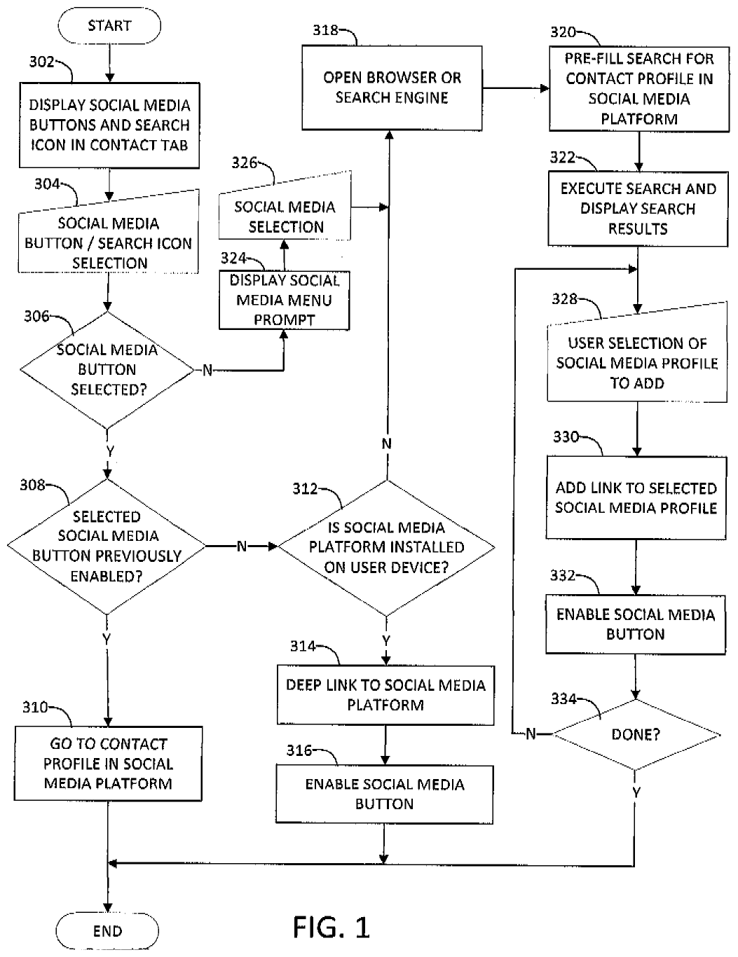

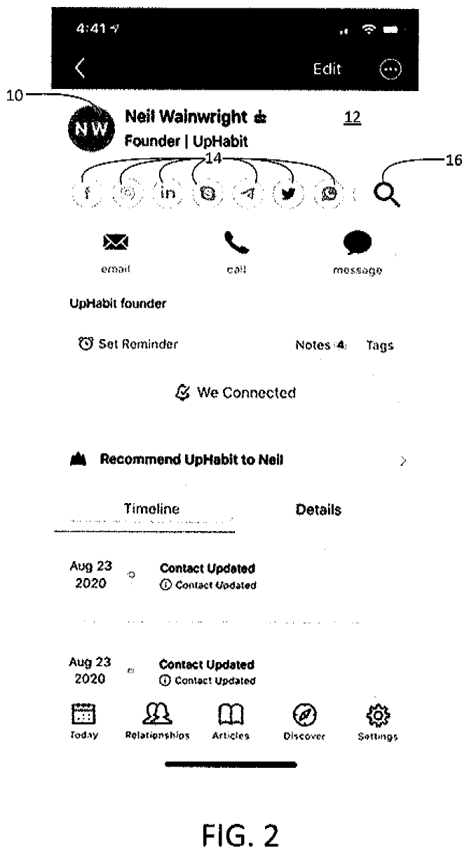

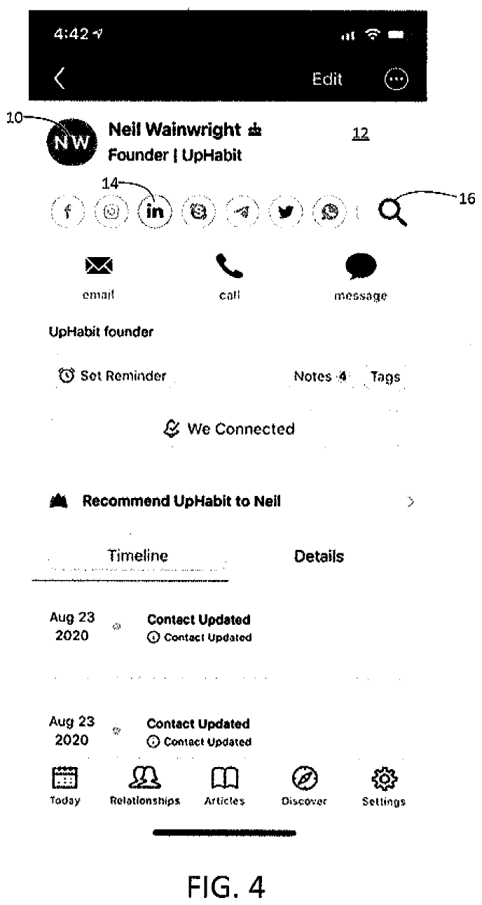

FIGS. 1-5 are referenced to describe a process for linking a social media profile corresponding to a contact 10 in a contact list of the UpHabit application to an associated social media button 14 displayed in a contact tab 12 of the UpHabit application. The various social media buttons 14 may be displayed under the contact's name 10 in contact tab 12. In the present example, there are seven social media buttons 14 displayed next to magnifying glass search icon 16 in contact tab 12. While a certain number of social media buttons 14 are illustrated, more or fewer buttons may be displayed. The shape, graphic, or other configuration of buttons 14 and search icon 16 may vary. For example, the social media buttons 14 may each include a logo, a symbol, and/or a word description that may reflect the branding of the social media platform. At least some of the social media buttons 14 are “greyed out” to indicate that the button is not yet enabled (i.e. the button is non-functional when tapped). By way of example, FIG. 2 shows all of the social media buttons 14 except the Twitter social media button (bird logo) in a disabled, greyed out state. A social media button 14 may be enabled and “filled in” (i.e. have at least one display attributed changed, for example from grey to colored) upon linking the contact's social media profile in the particular social media service to the UpHabit application. Once a social media button 14 is enabled, the user may easily access the particular social media profile for the contact by tapping the enabled social media button. For example, FIG. 4 shows the social media button 14 for the LinkedIn social media platform in an enabled, filled in state.

In the process embodiment of FIG. 1, display of social media buttons 14 and search icon 16 in contact tab 12 is represented by block 302. When a user taps a social media button 14 or the search icon 16, as indicated in block 304, the UpHabit application decides whether a social media button 14 or the search icon 16 was tapped pursuant to decision block 306.

If a social media button 14 was tapped, the UpHabit application determines process flow in decision block 308 depending upon whether or not the tapped social media button 14 was previously enabled (i.e. filled-in). If so, then the UpHabit application is configured to access the contact's social media profile in the social media service allocated to the chosen social media button 14 in accordance with block 310. As may be appreciated, the user is provided with one-tap access to the desired social media profile of the contact. As will be described below, a social media button 14 may be enabled if the associated social media service platform is installed on the user's mobile device and a link to the social media profile was previously created.

Returning to decision block 308, if the social media button 14 tapped by the user is not enabled (i.e. greyed out), then process flow branches to decision block 312. If the social media platform associated with the tapped social media button 14 is installed on the user's mobile device, then the UpHabit application is configured to create a link to the contact's social media profile in the selected social media platform as indicated by block 314. Social media platform applications typically allow for deep linking into their applications, with varying degrees of abilities exposed. After the social media profile is linked to the UpHabit application, tapping the enabled social media button 14 will deep link into the local social media application (e.g., Twitter) and open the social media profile of the identified contact as described above. In an instance to find a social media profile, the local application can be searched or used to search. Once the link has been created by the UpHabit application, the corresponding social media button 14 is enabled pursuant to block 316 for one-tap access to the linked social media profile, and the display attributes of the social media button 14 are changed from greyed out to filled in as illustrated in FIG. 4.

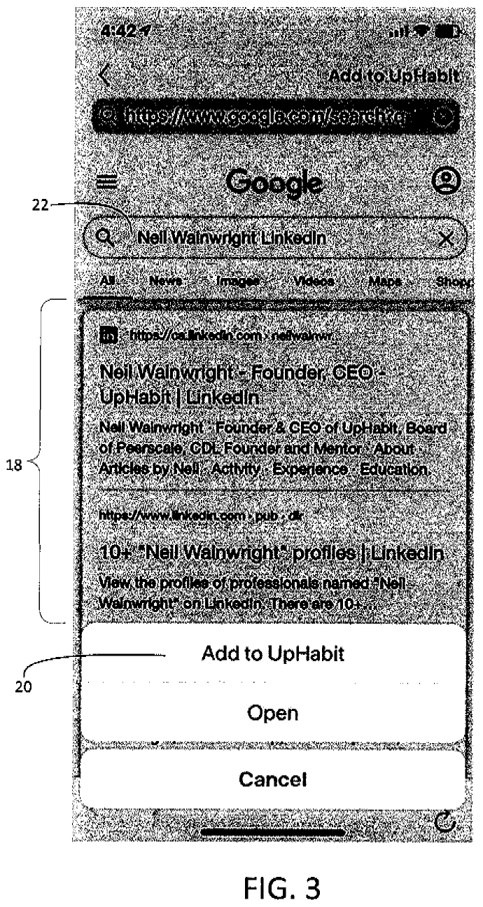

If, in decision block 312, the corresponding social media platform is not installed on the user's mobile device, then the UpHabit application may open a browser or search engine, for example, within the UpHabit application, to search the World Wide Web via the Internet for the contact in accordance with block 318. For example, a search engine such as Google or another search engine may be used. As indicated in block 320, a default search command may be pre-filled in the search field. In one embodiment, the UpHabit application may be configured to generate and pre-fill a search command having the format “Contact Name+Social Platform” in search field 22. In the example of FIG. 3, searching for Neil Wainwright on LinkedIn after trying to tap the LinkedIn button in the UpHabit application will pro-fill the search command “Neil Wainwright LinkedIn.” The search command generated by the UpHabit application may also include a company name, a domain, and/or another identifier as a secondary search term to narrow the search results. Then, as shown in block 322, the UpHabit application may automatically execute the search and display the search results. Alternatively, the UpHabit application may pre-fill the search command and wait for user input before executing the search and displaying the results, whereby the user has an opportunity to edit the pre-filled search command. Use of pre-filled search commands generated by the UpHabit application quickens the time to results and prevents typographic errors by the user. The search results 18 may be displayed according to a format used by the search engine, as shown in FIG. 3. The “Open” button in FIG. 3 can open a result from the search results 18 in the application (e.g., the LinkedIn application) or can open in a web browser. Opening in a web browser may allow more information to be pulled from a profile, such as a photo or headline text (e.g., company name or title). In an instance, a user can select whether to open in an application or with a web browser. Whether to open in an application or with a web browser also can be a preference set by the user. Additional “Open” options can be provided in the user interface to allow opening in an application or with a browser.

If, instead of selecting one of the social media buttons 14, the user selects search icon 16 displayed in contact tab 12, decision block 306 will direct the process to block 324, whereby the user is prompted to select a social media platform from a menu of choices for linking to the UpHabit application. For example, a pop-up menu may be displayed to the user with various social media platforms (e.g. Facebook, Instagram, LinkedIn, Skype, Telegram, Twitter, WhatsApp, YouTube, or others) for user selection. The user selects a desired social media platform in block 326, and then the process flow described in the immediately preceding paragraph may be followed leading to displayed search results according to block 322.

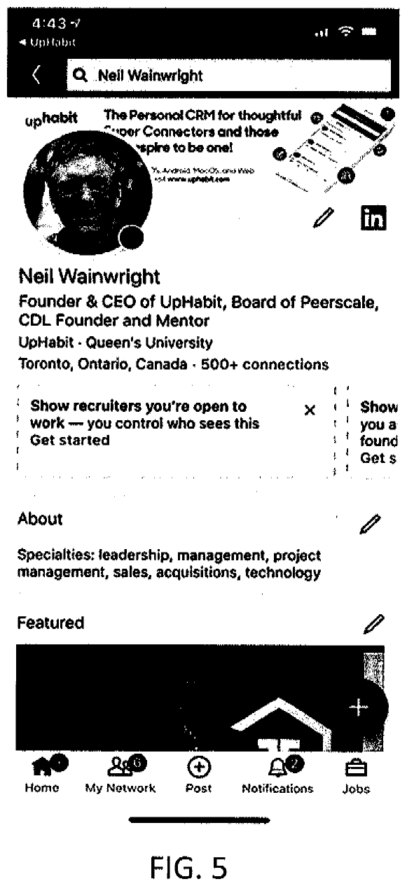

Once the search is made and the results 18 displayed according to block 322, the user chooses which social media profile to add to the UpHabit application pursuant to block 328. For example, the UpHabit application may be configured to display an “Add to UpHabit” prompt 20 such that a selected social media profile in the search results may be added to the UpHabit application by the user tapping “Add to UpHabit.” The UpHabit application may be configured such that the “Add to UpHabit” prompt 20 may hover over the search result window or remain adjacent the top or bottom of the search result window during navigation and/or searching. The UpHabit application is configured to link the corresponding social media button 14 to the selected social media profile (e.g., to the web address in the search results or a web address displayed on the screen) according to block 330. The UpHabit application is further configured to enable the functionality of the corresponding social media button 14 in contact tab 12 and change the display attributes of the button from “greyed out” to “filled in” as indicated by block 332. For example, FIG. 4 illustrates the filled in LinkedIn social media button 14 following addition of a link to the contact's LinkedIn profile. Subsequently, the user may directly access the LinkedIn profile of the contact by tapping the enabled social media button 14 for LinkedIn. FIG. 5 shows an exemplary LinkedIn profile accessed after it was added to the UpHabit application. As may be understood from decision block 334, this selection and addition routine may be carried out multiple times to create links to contact profiles from each of the available social media platforms and enable the corresponding social media buttons 14 for one-tap access.

The UpHabit application may be configured to permit a user to manually add links to social media profiles if the user cannot find a desired profile via search icon 16. In one embodiment, the UpHabit application may be configured to add a link to a social media profile via an “Edit” function on the contact tab. Tapping the +icon in the edit section may bring up a social media platform list. The user may choose which type of social media profile to add, and then input the contact's username or page URL. Once the username or URL is inputted, the user may tap “Save” and the corresponding social media button 14 will be enabled and filled in. This can be done for each social media platform. This method can be used to add a social media profile or update an existing social media profile.

Once enabled and filled in, the social media button 14 may be tapped to cause the UpHabit application to take the user directly to the contact's profile in the corresponding social media platform. The UpHabit application allows easy linking to various social media platforms and quick access to contact profiles in each platform.

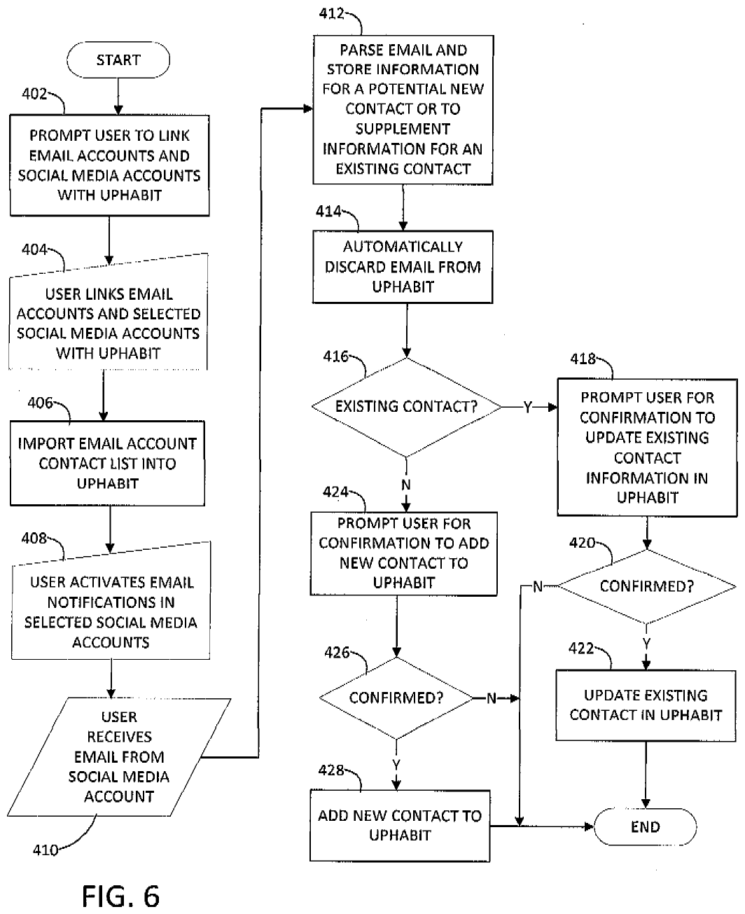

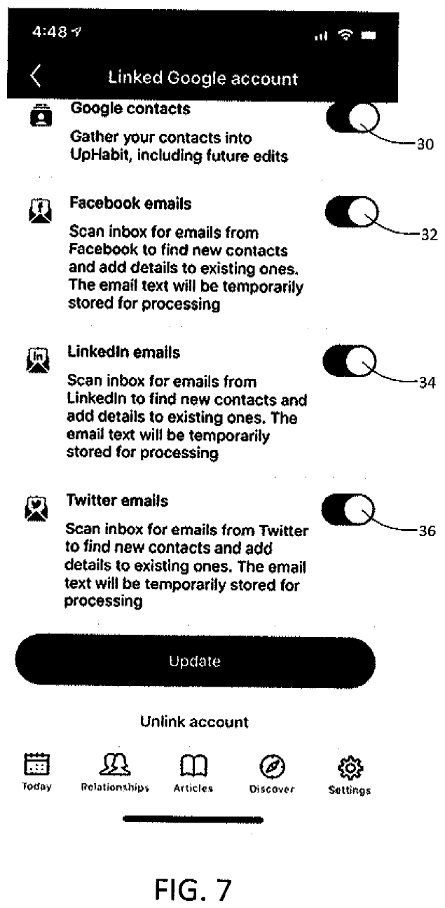

In a second aspect of the disclosure, a process is provided for adding new contacts and supplementing information for existing contacts in a contact list of an application (e.g. a mobile application or a web application) by leveraging a user's application accounts and social media accounts. Reference is made to FIGS. 6 and 7 for describing the process.

Embodiments disclosed herein provide a greater connection between a user's application accounts (e.g., Google and Microsoft email accounts) and social media accounts (e.g. Facebook, LinkedIn, and Twitter), on the one hand, and an application, for example the UpHabit application used for illustration in the present disclosure, on the other. The UpHabit application may be configured to have a plurality of user settings each corresponding to a respective application account or social media account of the user.

By way of non-limiting example, and as shown in FIG. 7, the UpHabit application may have a setting toggle 30 for linking the user's Google email (Gmail) account to the UpHabit application and importing the user's contact data from the Google account, including subsequent data updates, into the UpHabit application. The user may activate the setting toggle 30 to permit the UpHabit application to link to the account contact data. Linking to other email accounts (e.g. Microsoft) may be supported by the UpHabit application, and additional setting toggles may be provided in the UpHabit application for such accounts.

Also by way of non-limiting example, and as shown in FIG. 7, the UpHabit application may have setting toggles 32, 34, and 36, one for each of Facebook, LinkedIn, and Twitter. Other social media accounts may be supported by the UpHabit application, and these three social media accounts are merely used as examples. Fewer than three social media accounts or more than three social media accounts are possible. The respective setting toggles 32, 34, and 36 may be activated by the user to permit emails and messages received in the inbox of the corresponding social media account to be accessed by the UpHabit application to gather information that may be used by the UpHabit application as will be described below. The user may also need to turn on email notifications on the particular social media platforms for LinkedIn Invites, Facebook Birthdays, Friend Requests, Messages, and Twitter Direct Messages to allow the UpHabit application to access the emails and messages. For sake of simplicity, the term email is used herein to refer to all forms of electronic messages.

With regard to the second aspect of the present disclosure, FIG. 6 illustrates process flow according to an embodiment of the UpHabit application configured to add new contact information and supplement existing contact information in the UpHabit application based on information in other accounts of the user.

In block 402, the user is prompted to link email accounts and social media accounts with the UpHabit application. As described above with reference to FIG. 7, prompting may be done using setting toggles 30, 32, 34, and 36. The user then links selected email accounts and social media accounts to the UpHabit application by activating the corresponding setting toggles as indicated in block 404. In accordance with block 406, the UpHabit application may be configured to gather and import the user's contacts from each email account, and to update such contact information in the UpHabit application when a change in contact information is made in the local email account. As shown in block 408, the user may need to activate email notifications in the selected social media accounts. Pursuant to blocks 402 through 408, the user may grant permission for the UpHabit application to access emails received by the user in the user's social media accounts. The UpHabit application may be configured such that it only accesses specific emails sent from LinkedIn (invitations@linkedin.com), Facebook (notications@facebookmail.com), Twitter (notify@twitter.com), or others. The types of emails can be limited based on granular permission granted by the user. This limits access by the UpHabit application to only the potentially most relevant emails, and also restricts the UpHabit application from accessing non-public information by the application.

In block 410, the user receives an email from a social media account. The UpHabit application may be configured to analyze the contents of the email and store information for a potential new contact to add to the UpHabit application, or to supplement information for an existing contact in the UpHabit application, as indicated by block 412. For example, the UpHabit application may be configured to scan LinkedIn Invites, Facebook Birthdays, Friend Requests, Messages, and Twitter Direct Messages to gather information contained in the emails. The various emails may alert the user to a connection request, an upcoming event, or other periodic updates about members of the user's network. The UpHabit application may be configured to parse information such as individual names, birthdays, social media profiles, photographs, company names, job titles, or other data. For example, the UpHabit application may be configured to search for names, a photograph, or an URL and store it as a potential contact or update to an existing contact. For example, the UpHabit application may be configured to apply parsing algorithms to the content of the email, not limited to emails of a particular social media platform, to identify strings of characters from the email content, that potentially match contact information of individuals such as names, birthdays, social media profiles, photographs, company names, job titles, or other data. For example, the parsing algorithm may include a RegEx function that is configured to define an expression that defines the contact information of interest and to look for match results from a character string of inputs in the email content. For example, the contact information of interest can be names, birthdays, social media profiles, company names, job titles, or other data previously known from the contact. In one instance, a function may be designed to return undefined elements of an input string by returning the remainder of the input string that was not defined as a RegEx expression. For example, a social media URL can be the input string, the typical contents of a Social media URL can be defined as a RegEx expression and the undefined remainder of the URL, which may be the user name, can be returned. In one instance, the social media application redirect link may be used to retrieve a user name. For example, the typical contents of a social media application redirect URL can be defined as a RegEx expression and the undefined remainder of the URL, which may be the user name, can be returned. In an instance, a social media profile URL may be returned using the username. In an instance, the profile image can be retrieved from Rich Text in the email message similar to methods described above. In one instance, the URL may be obtained from a URL fragment, which may be a subsection of a URL web page. Subsequently the username may be retrieved from the URL as described above. In one instance, the text of the email may be scanned for individual names directly. In one instance, upon successful connection with an individual via the social media platform, the UpHabit application may further be configured to retrieve birthdays, contacts from social media, company names, job titles, or other data from the linked social media profile of said individual. The potential contact information or supplemental update information may be stored in a database of the UpHabit application. In accordance with block 414, the UpHabit application may be configured to automatically discard the body of the email from memory used by the UpHabit application after scanning, parsing, and analysis of the email is completed.

Pursuant to decision block 416, the UpHabit application may be configured to analyze the information gathered from the email to determine whether the information relates to an existing contact of the user that is already in the user's UpHabit application contact list, or to a potential new contact to be added to the user's UpHabit application contact list. For example, if the URL, name, and/or name combination already exists in the user's UpHabit application contact list, then the UpHabit application may be configured to prompt the user in block 418 for confirmation to update the existing contact information in the UpHabit application contact list before any changes are made. If the user gives confirmation, decision block 420 directs flow to block 422 in which the UpHabit application updates the existing contact information in the UpHabit application contact list. However, if the user does not give confirmation, decision block 420 directs flow to bypass the update step of block 422.

Referring back to decision block 416, if the UpHabit application determines that the information relates to a potential new contact to be added to the user's UpHabit application contact list, then decision block 416 directs process flow to block 424. For example, if the URL, name, and/or name combination does not already exist in the user's UpHabit application contact list, the UpHabit application will proceed to block 424. As indicated by block 424, the UpHabit application may be configured to prompt the user for confirmation to add the new contact to the UpHabit application contact list. If the user gives confirmation, decision block 426 directs flow to block 428 in which the UpHabit application creates and adds the new contact to the UpHabit application contact list. However, if the user does not give confirmation, decision block 426 directs flow to bypass the creation and addition step of block 428.

Deduplication can be performed on the UpHabit application contact list to avoid duplicate contacts that do not share a unique profile on a social media platform. For example, each contact may be scanned to determine if a unique social media profile is associated therewith. Further contacts may be ranked with varying levels of importance based on the number or type of social media profiles associated with the contact. This ranking may be used to remove duplicates with less important information. The ranking based on number or type of social media profile is non-limited and may be incorporated in any possible combinations. In an instance, the UpHabit application may provide the user with an option to decide on the ranking.

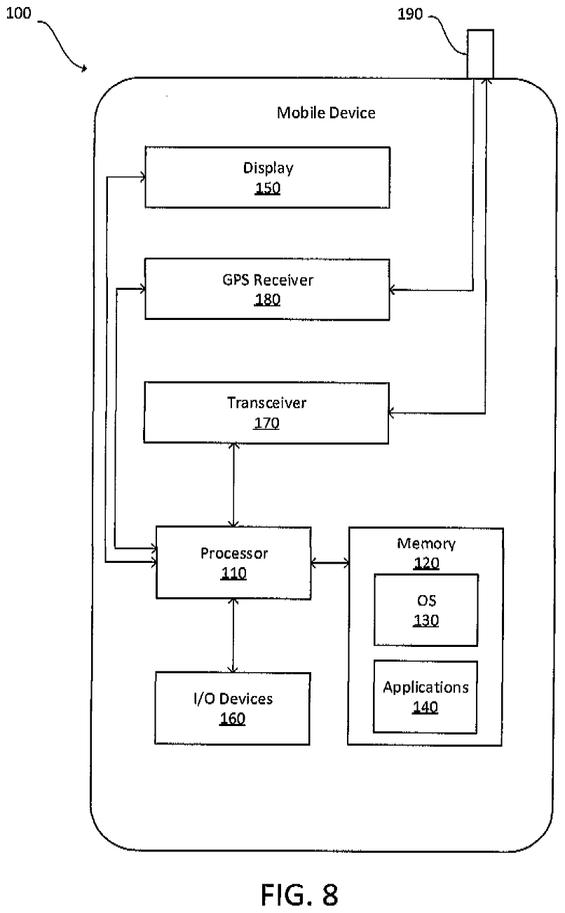

FIG. 8 is a block diagram illustrating a mobile device 100 for running the UpHabit application according to an example embodiment. The mobile device may correspond to, for example, one or more client machines or application servers. One or more embodiments of the method described herein may be implemented on or executed by the mobile device 100. The mobile device 100 may include a processor 110. The processor 110 may be any of a variety of different types of commercially available processors suitable for mobile devices (for example, an XScale architecture microprocessor, a Microprocessor without Interlocked Pipeline Stages (MIPS) architecture processor, or another type of processor). A memory 120, such as a Random Access Memory (RAM), a Flash memory, or other type of memory, is typically accessible to the processor 110. The memory 120 may be adapted to store an operating system (OS) 130, as well as application programs 140, such as a mobile location enabled application that may provide location based services to a user. The processor 110 may be coupled, either directly or via appropriate intermediary hardware, to a display 150 and to one or more input/output (I/O) devices 160, such as a keypad, a touch panel sensor, a microphone, and the like. Similarly, in some embodiments, the processor 110 may be coupled to a transceiver 170 that interfaces with an antenna 190. The transceiver 170 may be configured to both transmit and receive cellular network signals, wireless data signals, or other types of signals via the antenna 190, depending on the nature of the mobile device 100. Further, in some configurations, a GPS receiver 180 may also make use of the antenna 190 to receive GPS signals.

Certain embodiments are described herein as including logic or may operate using one or more components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Accordingly, software may configure a processor to constitute, for example, a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that-connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to heroin may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product (e.g., a computer program) tangibly embodied in an information carrier (e.g., in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be custom-developed for a particular hardware, in its dedicated software development environment. As a non-limiting example, an Android application program can be developed for a hardware running an Android OS and an IOS application program can be developed for a hardware running an IOS and so on. A computer-software-user-interface can be custom-developed for a particular hardware, in its dedicated software development environment. A computer program may partially include a web based software language. A computer program may also include native software languages and in some instances, may be built entirely with native software languages. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, such as a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Embodiments disclosed herein can store or access information on the client or the server.

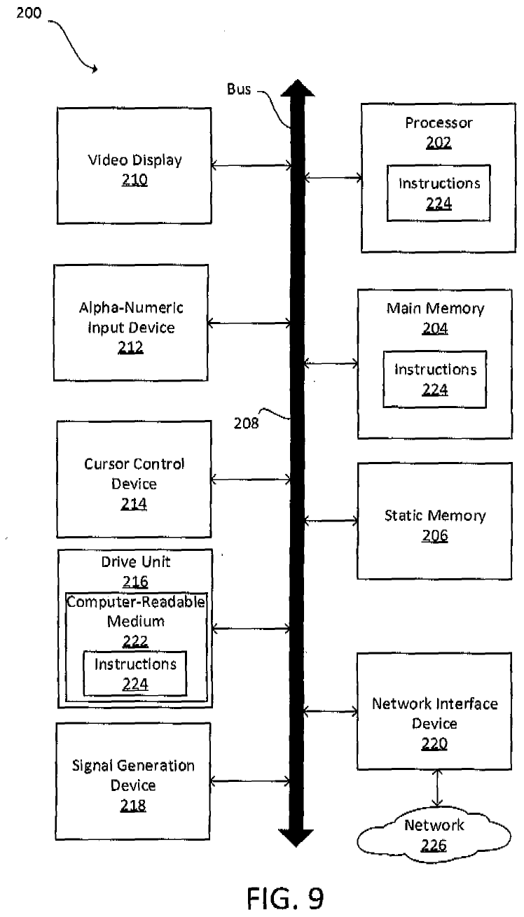

FIG. 9 is a block diagram of a machine in the example form of a computer system 200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU), a graphics processing unit (GPU), or both), a main memory 204, and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard or a touch-sensitive display screen), a user interface (UI) navigation device 214 (e.g., a mouse), a disk drive unit 216, a signal generation device 218 (e.g., a speaker), and a network interface device 220.

The disk drive unit 216 includes a machine-readable medium 222 on which is stored one or more sets of instructions and data structures (e.g., software) 224 embodying or utilized by any one or more of the methodologies or functions described herein. The instructions 224 may also reside, completely or at least partially, within the main memory 204 and/or within the processor 202 during execution thereof by the computer system 200, the main memory 204 and the processor 202 also constituting machine-roadable media.

While the machine-readable medium 222 is shown in an example embodiment to be a single medium, the term “machine-readable medium” may include a single medium or multiple media (e.g., a centralized or distributed database and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, optical, and magnetic media. Specific examples of machine-readable media include non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 224 may further be transmitted or received over a communications network 226 using a transmission medium. The instructions 224 may be transmitted using the network interface device 220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
displaying, using a processor, a social media button in a contact tab for a contact in an application, wherein the social media button represents a social media platform, and wherein the social media button is not enabled;
receiving, using the processor, a button press input from a user pressing the social media button;
performing, using the processor, a search for a social media profile for the contact in response to the button press input;
displaying, using the processor, a list of social media profile search results;
receiving, using the processor, an input from the user selecting a desired social media profile from the list of social media profile search results;
linking, using the processor, the selected social media profile to the social media button; and
enabling, using the processor, the social media button such that the selected social media profile is accessible by pressing the social media button.

2. The method of claim 1, wherein the search is performed using an in-application window within the application.

3. The method of claim 1, further comprising generating, using the processor, a search command for performing the search, wherein the search command includes the name of the contact and a term related to the social media platform.

4. The method of claim 3, further comprising pre-filling, using the processor, the search command in a search engine.

5. The method of claim 1, wherein the step of enabling the social media button includes changing at least one display attribute of the social media button.

6. A system configured to perform the method of claim 1.

7. The system of claim 7, wherein the system is a mobile device configured to execute the application.

8. A non-transitory computer readable medium storing a program configured to instruct a processor to execute the method of claim 1.

9. A method comprising:
displaying, using a processor, a social media button and a search icon in a contact tab for a contact in an application, wherein the social media button represents a social media platform, and wherein the social media button is not enabled;
receiving, using the processor, an icon press input from a user pressing the search icon;
displaying, using the processor, a menu of social media platforms in response to the icon press input;
receiving, using the processor, a menu selection input from the user corresponding to a social media platform selected from the menu of social media platforms, wherein the selected social media platform is represented by the social media button;
performing, using the processor, a search for a social media profile for the contact in response to the menu selection input;
displaying, using the processor, a list of social media profile search results;
receiving, using the processor, an input from the user selecting a desired social media profile from the list of social media profile search results;
linking, using the processor, the selected social media profile to the social media button; and
enabling, using the processor, the social media button such that the selected social media profile is accessible by pressing the social media button.

10. The method of claim 9, wherein the search is performed using an in-application window within the application.

11. The method of claim 9, further comprising generating, using the processor, a search command for performing the search, wherein the search command includes the name of the contact and a term related to the social media platform.

12. The method of claim 11, further comprising pre-filling, using the processor, the search command in a search engine.

13. The method of claim 9, wherein the step of enabling the social media button includes changing at least one display attribute of the social media button.

14. A system configured to perform the method of claim 9.

15. The system of claim 14, wherein the system is a mobile device configured to execute the application.

16. A non-transitory computer readable medium storing a program configured to instruct a processor to execute the method of claim 9.

17. A method comprising:
analyzing, using a processor, an email for information about a contact;
determining, using the processor, whether the contact is an existing contact in an application contact list or a potential new contact not currently in the application contact list based on the analyzed information;
automatically discarding, using the processor, the email after the analyzing is complete;
updating information about the contact in the application contact list if the contact is an existing contact in the application contact list; and
adding the contact to the application contact list if the contact is a potential new contact not currently in the application contact list.

18. The method of claim 17, further comprising receiving, using the processor, user permission to access the email.

19. The method of claim 17, further comprising receiving, using the processor, input from a user confirming updating the existing contact before the updating.

20. The method of claim 17, further comprising receiving, using the processor, input from a user confirming adding the potential new contact before the adding.

21. The method of claim 17, wherein the information about the contact includes a name or a birthday.

22. A system configured to execute the method of claim 17.

23. The system of claim 22, wherein the system is a mobile device.

24. A non-transitory computer readable medium storing a program configured to instruct a processor to execute the method of claim 17.
